(19) United States
(12) Patent Application Publication
(10) Pub. No.: US 2003/0177674 A1
(43) Pub. Date: Sep. 25, 2003

(54) Method and apparatus for advertising and promoting having a peel-away label

(76) Inventor: Gary Raymond Miller, Ann Arbor, MI (US)

Correspondence Address: GARY R. MILLER, 1903 BRECKLAND DRIVE, ANN ARBOR, MI, 48108, US

(21) Appl. No.: 10/393,479

(22) Filed: Mar. 20, 2003

Related U.S. Application Data
(60) Provisional application No. 60/366,203, filed on Mar. 21, 2002.

(51) Int. Cl. G09F 3/02

(52) U.S. Cl. 40/27.5; 40/638

(57) ABSTRACT

A system and method for providing a token with a complimentary coupon for distribution to patrons of different entities and events. A small and relatively inexpensive complimentary item may be mass produced for mass distribution to patrons or prospective patrons of different entities or events. The comp items may serve as an advertising or promotional tool as well. Each comp item, however, will include a removable comp coupon which will indicate a more valuable gift than the comp item itself. Furthermore, the comp item includes identifying marks and logos so that the patron or prospective patron will have an immediate remembrance or indication of the provider of the comp item. Additionally, the comp coupon is provided on the comp item in a tamper or pilfer resistant manner so that it is not easily removed yet removable by a patron who receives the comp item.

### FIELD OF THE INVENTION

The present invention relates generally to an advertising or promotional device for use by any entity desiring to give a complimentary gift, and more particularly to a complimentary device which has a peel-away label to disclose such complimentary gift.

### BACKGROUND OF THE INVENTION

In many industries and on many celebratory occasions, it is often desirable to provide gifts or complimentary items to patrons. Most often, the gift is provided in either secretive packaging or as an obvious item. In addition, the item may represent the occasion or entity itself. Often, the item alone is the gift or compliment.

Other known systems allow that a hidden compliment or gift is provided on a gaming piece. Such is generally known in scratch off lottery systems. A card includes a statement or prize hidden by a removable peeling or covering. Removing this covering reveals the prize. These systems and devices, however, generally provide that only the card itself indicates a compliment or prize to be won, but includes no other tangible winning or gift.

It is often desirable to provide a token or system where both a gift, which is valued greater than the token itself, and a memorable or collectible token may be provided. Furthermore, it is desirable to provide a token which is commemorative of the event or entity providing the gift, especially if the gift is more temporary. Therefore, a token or device that provides both a complimentary gift and an advertisement is desired.

### SUMMARY OF THE INVENTION

A system and method for providing a token with a complimentary coupon for distribution to patrons of different entities and events. A small and relatively inexpensive complimentary item may be mass produced for mass distribution to patrons or prospective patrons of different entities or events. The comp items may serve as an advertising or promotional tool as well. Each comp item, however, will include a removable comp coupon which will indicate a more valuable gift than the comp item itself. Furthermore, the comp item includes identifying marks and logos so that the patron or prospective patron will have an immediate remembrance or indication of the provider of the comp item. Additionally, the comp coupon is provided on the comp item in a tamper or pilfer resistant manner so that it is not easily removed yet removable by a patron who receives the comp item.

In one embodiment of the present invention is a collectible chip or coin, associated with an entity who generally provides chips or coins, which is oversized in diameter and/or thickness to a regular chip or coin provided by that entity. A tamper-proof and pilfer resistant peel-away complimentary or “comp” label or coupon is included on the back side of the chip or coin. The comp coupon is removable by a patron to reveal a complimentary or “comp” gift. The sponsoring entity provides the complimentary gift which is indicated on the comp coupon. Also printed on the collectible chip or coin is a name, location, and other identifying features, such as a logo, to indicate from where the collectible chip or coin originated. Because the comp coupon is removable, the comp coupon provides the currency for the complimentary gift while allowing the patron to permanently retain the collectible chip or coin.

In another embodiment, a comp coupon is placed in an inlay which is a slight indentation in the collectible chip or coin. Because the comp coupon is adhered in the inlay it provides an inherent tamper resistance to the coupon. Furthermore, the type and strength of adhesive can be varied depending upon the amount of security or tamper resistance desired.

In yet another embodiment, the collectible chip or coin is not associated with a particular entity, but rather with an event. In this way, a complimentary coupon is provided on a collectible chip or coin which has the name, location, or other identifying features of a particular event, such as a Mardi Gras parade or a convention. This will allow a patron, who receives the collectible coin or chip, to receive a permanent reminder of the event while also allowing the event to provide a larger gift than the collectible token or chip to the patron.

In still a further embodiment, a collectible toy or item is provided with a comp coupon. The complimentary toy or item itself resembles the event or entity providing the complimentary toy or item. Furthermore, the complimentary toy or item is simply a toy or item for a patron which receives it. In this way, the complimentary toy or item provides a function beyond a collectible chip or token. On the complimentary item or toy, however, is a comp coupon. The comp coupon is affixed to the complimentary item or toy through any appropriate means that will provide for a tamper resistant affixation, while allowing for easy removal by a patron receiving the complimentary item or toy. A comp chip or comp coin may also be inserted into a pocket formed into the complimentary toy. Again, this allows for an event or entity to provide a permanent token of remembrance for a patron while also providing a means of distributing larger or more expensive gifts and items to patrons.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevational view of a front side of a complimentary or comp chip;

FIG. 2 is an elevational view of the back side of the comp chip;

FIG. 3 is a cross sectional view of the comp chip;

FIG. 4 is an elevation view of a comp coupon, partially revealed, and system;

FIGS. 4a-4d are detail views of the comp coupon and system;

FIG. 5 is an elevational view of a front side of a comp coin;

FIG. 6 is an elevational view of the back side of a comp coin;

FIG. 7 is an elevational view of a front side of an event comp chip;

FIG. 8 is an elevational view of a back side of an event comp chip;

FIG. 9 is an elevational view of a front side of an event comp coin;

FIG. 10 is an elevational view of a back side of an event comp coin;

FIG. 11 is an elevational view of a comp toy; and

FIG. 12 is a top elevational view of a device for organizing comp items.

### DETAILED DESCRIPTION OF THE PREFERRED EMBODIMENTS

The following description of the preferred embodiment(s) is merely exemplary in nature and is in no way intended to limit the invention, its application, or uses.

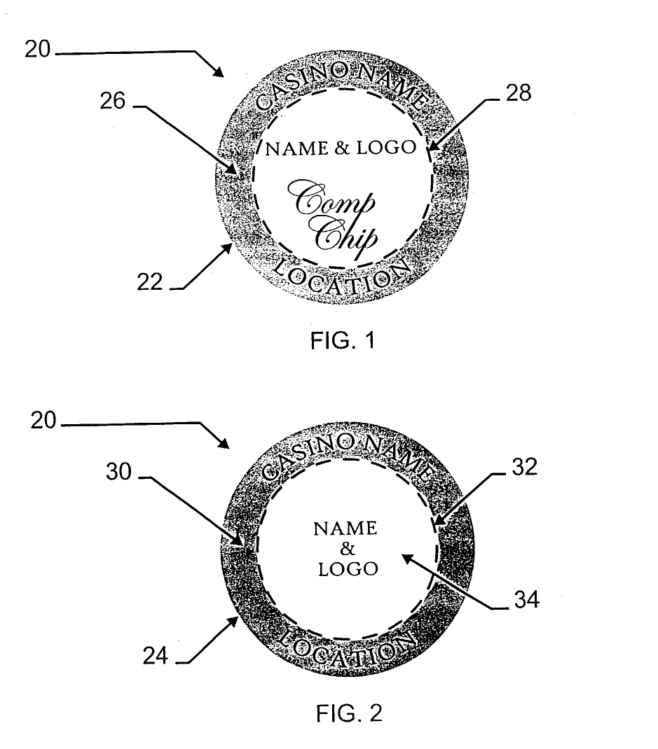

With reference to FIGS. 1 to 3 a complimentary item, according to a first embodiment of the present invention, is a complimentary (comp) chip 20. The comp chip 20 would typically be used by a casino to present to its patrons for various complimentary gifts. The comp chip 20 has a first or front face 22 and a second or back face 24. The front face 22 is defined by a front rim, collar, or ring 26 with a front inlay 28. The front inlay 28 is a depression or imprint formed in the front face 22. The front inlay 28 generally has a bottom surface which is a distance A below the edge of the front rim 26. The distance A, while depending upon the thickness of the comp chip 20 itself, is generally between about 0.25 mm and 2.0 mm.

The back face 24 of the comp chip 20 is defined by a back rim 30 and a back inlay 32. The back inlay 32 has a depth B. Again, the depth of the back inlay 32 is any appropriate depth, but that is generally between about 0.25 mm and 2.0 mm. Placed in the back inlay 32 is the peelable or removable comp label or comp coupon 34. The comp coupon 34, when positioned in the back inlay 32, is disposed a distance C below the back rim 30. The distance C is generally any appropriate distance but generally between about 0.001 mm and 0.25 mm.

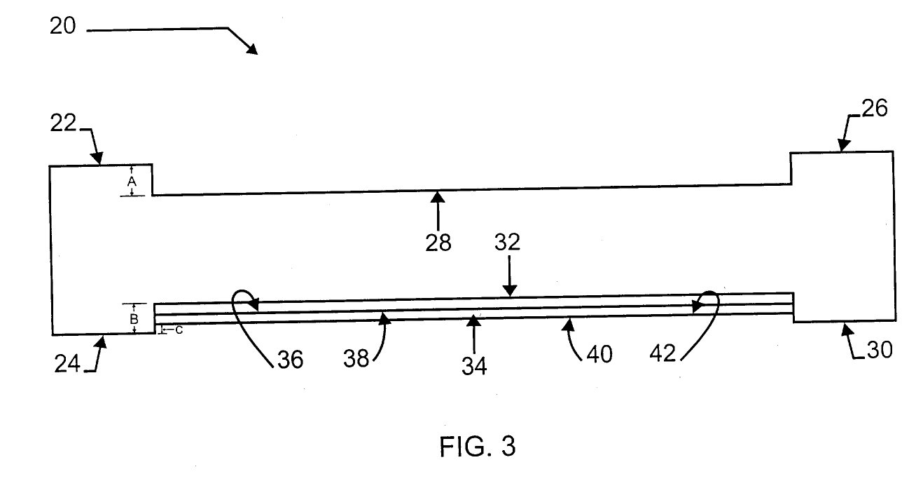

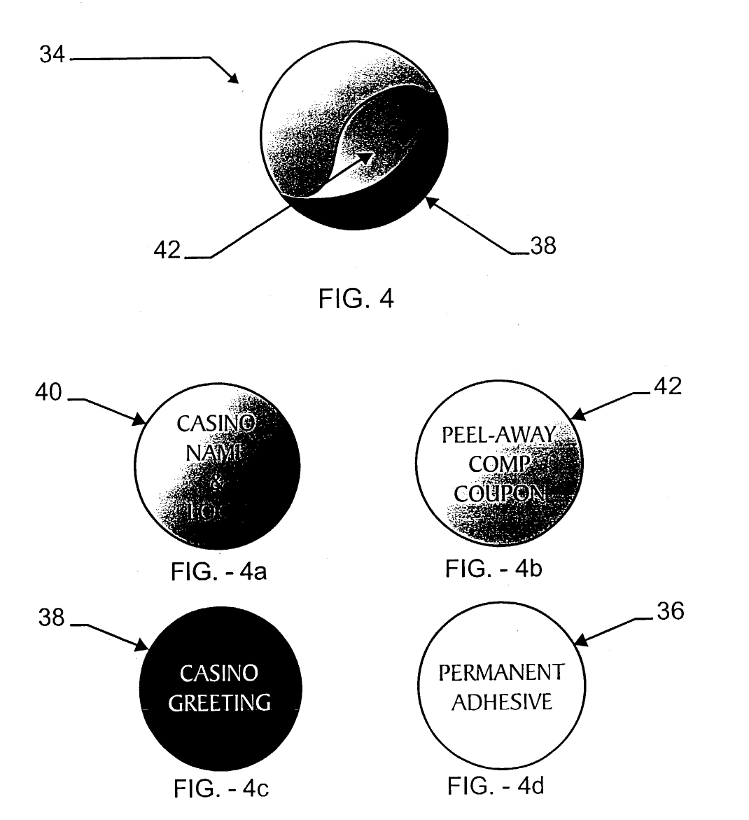

With reference to FIGS. 3 through 4D, the comp coupon 34 is described in greater detail. The comp coupon 34 is affixed to the back inlay 32 using a permanent and pressure sensitive adhesive 36. The adhesive 36 may either be a clear double sided adhesive, so that any greeting or notation made on the back inlay 32 is visible therethrough, or may be opaque, which includes a greeting or advertisement on the outside surface of the adhesive surface layer 36. In either case, a greeting layer 38 is visible once the comp coupon 34 has been removed. The comp coupon 34 is an opaque substrate which has a first or outside revealed side 40 including a casino or any other event or entity name, location, or other identifying features or advertisement. Placed on a second or hidden comp side 42 of the comp coupon 34 is an indication of a complimentary gift.

In this way, when a comp chip 20 is given to a patron, the patron is unaware of the complimentary gift which the patron may later obtain. That is, the comp side 42 is hidden because it is against the comp chip 20. Only once the comp coupon 34 has been removed from the adhesive 36 will the patron know the gift which the patron will receive. Therefore, the comp side 42 is selectively hidden to be revealed by the patron.

Because of the back inlay 32, the comp coupon 34 includes an inherent tamper or pilfer resistant feature. That being the comp coupon 34, because of the recessed nature of the back inlay 32, is either substantially flush or below the back rim 30. The comp coupon 34 will not easily or accidentally be removed from the comp chip 20 until it is intended to be removed by the patron to which it is given. Therefore, the comp chip 20 has a longevity even during storage and transportation. Additionally, the comp coupon 34 will not be accidentally lost by the patron before the patron has a chance to remove the comp coupon 34 and reveal the gift which the patron will receive.

The comp chip 20 may include any logo, advertising slogan, or other promotional display in the front inlay 28. The size of the comp chip 20 may be in the appropriate size to include any desired logo or name in the front inlay 28. Additionally, the event or entity may include slogans, addresses, locations, or other information on the front rim 26 and the back rim 30. Providing such information as to the entity or event location, name, and other identifying information will provide a permanent reminder for the patron who receives the comp chip 20.

The comp coupon 34 is the actual element of currency for the gift to be received by the patron. Therefore, the patron will not only receive a gift with the comp coupon 34, but the patron will have the additional permanent comp chip 20 to commemorate the event or occasion. The comp chip 20 itself may be made of any appropriate material depending upon the desires of the entity providing the comp chip 20. For example, if the entity desires to provide a precious comp chip 20, the comp chip 20 may be formed of a precious metal such as gold or silver. The comp chip 20, however, may also be formed of a base metal or a plastic material. In addition, the comp chip 20 may be formed of two or more materials. In particular, the center area which defines the inlay may be formed of a metal or plastic while the rim area is formed of a complimentary plastic or metal.

In addition, the comp chip 20 can be made to simulate, although with necessary distinguishing characteristics, such as size or color, the general chip of an entity such as a casino. Therefore, there will be an immediate recognition between the trade elements of a casino, which may give out a comp chip 20, and the comp chip 20 actually received by a patron. In this way, the comp chip 20 can be used as a visual aid for later remembrances of the experience where the patron received the comp chip 20.

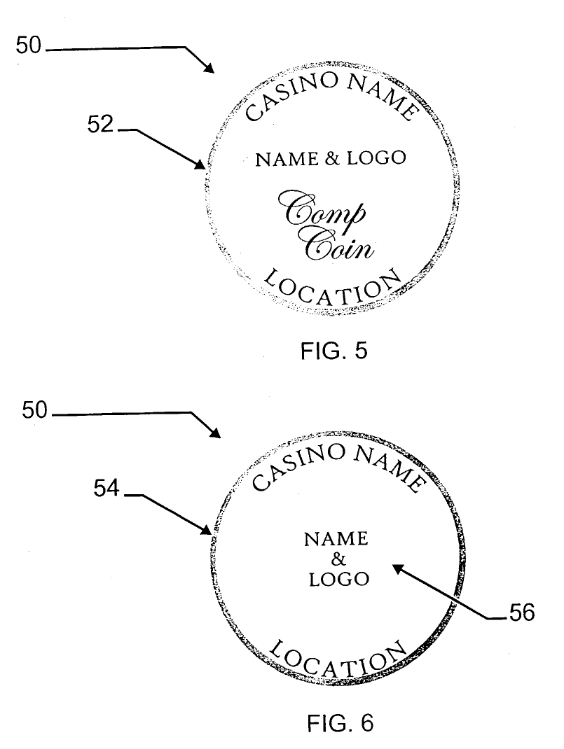

With reference to FIGS. 5 and 6, a complimentary item according to a second embodiment of the present invention is a complimentary coin or comp coin 50. The comp coin 50 includes a front face 52 and a back face 54. The front face 52 again includes any identifying logos, names, or locations of any entity or event for which a comp coin 50 is distributed. On the back face 54, a comp coupon 56 is included. The comp coupon 56 may either be set in an inlay or fixed to the back face 54 of the comp coin 50 with any appropriate adhesive. As described above, it is desirable to provide an adhesive that is resistant to inadvertent removal of the comp coupon 56, yet the adhesive must allow for easy removal of the comp coupon 56 by the patron. Therefore, if no inlay is used, the adhesive must be able to provide both functions.

In regard to the comp coin 50, however, it is desirable to more closely imitate a coin. Generally, a coin does not have a raised collar or outside edge and is substantially smooth across its face, save for any markings or indications. The comp coin 50 may still be made from any appropriate material, such as a plastic or metal depending upon the desires of the entity providing the comp coin 50. The comp coin 50 generally is substantially planar and made out of only a single material. Therefore, the comp coupon 56 is more substantially adhered to the back face 54 of the comp coin 50 than the comp coupon 34 is adhered to the back inlay 32 according to the first embodiment.

As discussed above however, the comp coupon 56 generally is opaque including a name, logo, or other identifying features on the outside surface of the comp coupon 56. The actual complimentary gift itself is indicated on the inside surface of the comp coupon 56. In this way, the gift is not known until the comp coupon 56 has been removed from the comp coin 50. In additional, a logo or identifying feature may be placed on the visible side of the adhesive. As noted above, such a logo may also be placed on the back face 54 of the comp coin 50 and visible through a transparent adhesive. In this way, when the comp coupon 56 is removed, a decorative logo or other indication of the event or entity remains on the comp coin 50.

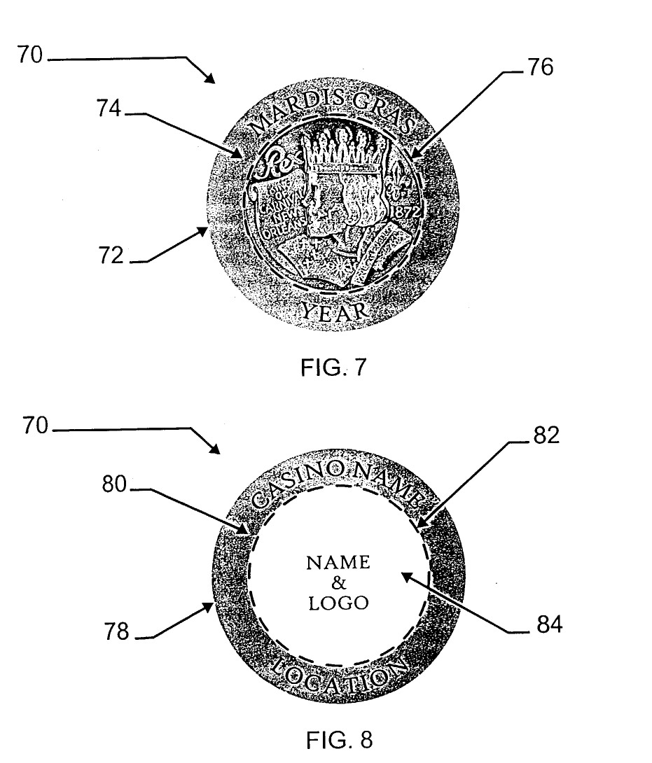

With reference to FIGS. 7 and 8, a complimentary item in the embodiment of an event comp chip 70 is illustrated. The event comp chip 70 includes a front face 72 which comprises a front rim or collar 74 around a front inlay 76. As discussed regarding the first embodiment, the front inlay 76 includes any appropriate logo or identifying features of the event. In particular, many events distribute tokens or gifts to patrons. In particular, the Mardi Gras event, in a city such as New Orleans, has Krewes which toss or hand out Krewe coins. In place of a Krewe coin, an event comp chip 70 may be used. As illustrated in FIG. 7, a relevant event picture or logo may be placed in the front inlay 76 to commemorate the event.

The event comp chip 70 also includes a back face 78 including a back rim or collar 80 with a back inlay 82. Placed in the back inlay 82 is a comp coupon 84. Methods and apparatuses for affixing the comp coupon 84 to an event comp chip 70 have been discussed above regarding the first embodiment comp chip 20. For example, a transparent, double sided adhesive or an opaque adhesive may be used to affix the comp coupon 84 to the back inlay 82. Furthermore, the comp coupon 84 may include the name or logo of any event or location where the comp coupon 84 may be redeemed. The back side of the comp coupon 84 indicates the actual complimentary gift to be received by the patron. With an event comp chip 70, the complimentary gift indicated on the comp coupon 84 may be from the event itself or from any sponsoring entity.

The event comp chip 70 provides the patron with a lasting and permanent token or reminder of the event. The comp coupon 84 provides the patron with a complimentary gift that may have a more substantial monetary value than the event comp chip 70. Therefore, any event desirous of providing a small token to numerous individuals may provide an event comp chip 70 while providing a range of gifts and different values indicated on the comp coupon 84.

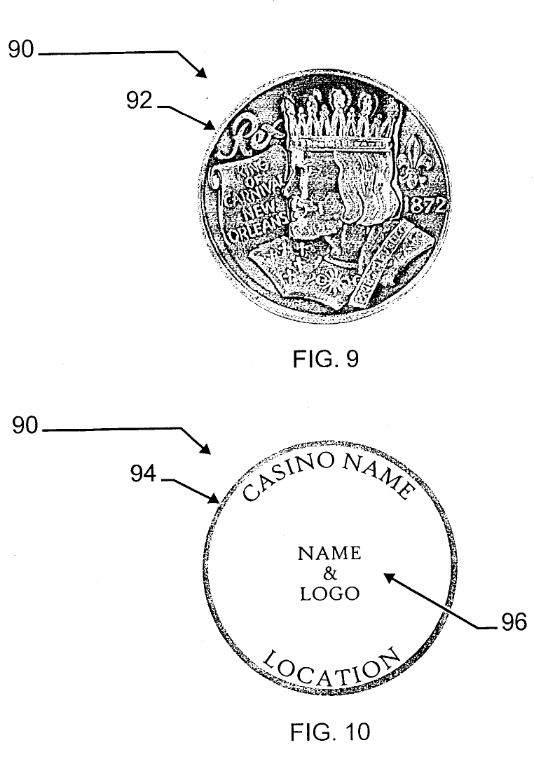

With reference to FIGS. 9 and 10, a complimentary item in the embodiment of an event comp coin 90 is illustrated. The event comp coin 90 is similar to the comp coin 50, according to the second embodiment, but may have a more event orientated picture on the front face 92 of the event comp coin 90. The event comp coin 90 has a substantially planar surface, save for any markings or indications placed thereon. The event comp coin 90 also includes a back face 94 comprising, a comp coupon 96. Again, as discussed above, the comp coupon 96 is affixed to the back face 94 of the event comp coin 90 by any appropriate means.

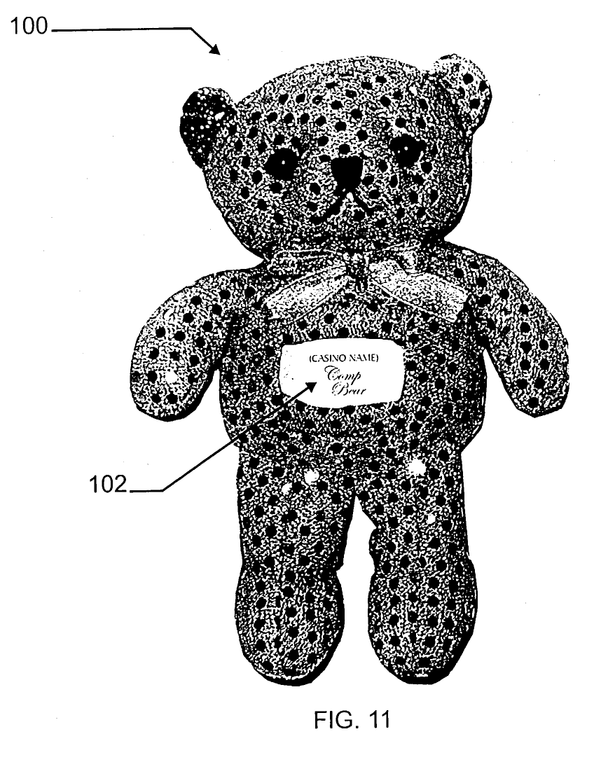

With reference to FIG. 11, a complimentary item in the embodiment of a comp toy 100 is illustrated. It will be understood that the comp toy 100 may be either an event or entity comp toy. It will also be understood that the comp toy 100 is not necessarily a bear or other animal. In particular, the comp toy 100 may more closely resemble the event or entity which is providing the comp toy 100. This provides a more real and distinct relation between the comp toy 100 and the event or entity providing the comp toy 100.

The comp toy 100, although it is understood that any appropriate figure or animal may be used, includes a comp coupon 102. The comp coupon 102 is affixed to the mid-section or body of the comp toy 100. It will be understood, however, that the comp coupon 102 may be affixed to any appropriate section of the comp toy 100. Simply the comp coupon 102 must be affixed to the comp toy 100 so that the comp coupon 102 is easily removed from the comp toy 100 by a patron, but will not be accidentally removed by shuffling or transporting the comp toy 100. The comp coupon 102 may be affixed to the comp toy 100 with stitching if the comp toy 100 is a plush or fabric item. The comp coupon 102, however, may also be affixed to the comp toy 100 with an adhesive, such as that described above, if the comp toy 100 is formed of a hard or smooth material.

The outside surface of the comp coupon 102 provides any name or logo of a sponsoring event or entity to properly verify the comp coupon 102 the comp coupon 102 is then redeemed for the appropriate gift indicated on the back side of the comp coupon 102. The comp toy 100 may also include any special logos or indicative names depending upon the desires of the promoting entity or event.

The comp toy 100 may also include a pocket or pouch which is formed on the comp toy 100 which may then hold a comp chip or comp coin. That being, that rather than placing the comp coupon 102 directly onto the comp toy 100, the comp coupon 102 may be placed on a comp chip or comp coin as discussed in relation to the other embodiments. For example a comp chip 20 may be held between a first slit or fold of fabric and a second slit or fold of fabric. Also, a large pocket may receive a comp chip 20. The comp toy 100, on the body or other portion, may either include markings or no markings, other than the pocket to hold the comp chip or comp coin.

In addition to the device for an event or entity to provide a complimentary gift to a patron, along with a more permanent complimentary item, the sponsoring event or entity may also indicate on or with the complimentary item other information. In particular, the complimentary item may be different depending upon the value of the comp coupon. Therefore, a plurality of different colors, shapes, or sizes may be used to form the complimentary items depending upon the value of the comp coupon. This will provide a quick and visual indication of the relative or range of value of the particular complimentary gift. It will also offer an easy discrimination, by the event or entity sponsoring the complimentary gift, without actual knowledge of the particular complimentary gift.

One example is that if a comp chip 20, according to the first embodiment, had a different color depending upon the relative range of value of the complimentary gift, indicated by the comp coupon 34, then a very quick and easy discrimination, by the entity providing the comp chip 20, method to determine the relative value is available. In particular, a first color is used for a range of values between, for example one dollar and twenty dollars, a second color for a second range of values, between about twenty dollars and about one hundred dollars, and a third color for a third range above about one hundred and one dollars. Therefore, the entity provides comp chips having three distinct colors associated with a particular complimentary gift value range so that the entity would be able to quickly distinguish which comp chip 20 the entity desired to provide to a particular patron. It will also be understood that rather than each complimentary item having a discrete value between a particular range, an entire series of complimentary items might have a very broad range, for example between a $2.00 prize and a $10,000 grand prize. Wherein the entire series would have very few grand prizes, but many smaller prizes. Therefore, the average value of the series could also be indicated by color, shape, size.

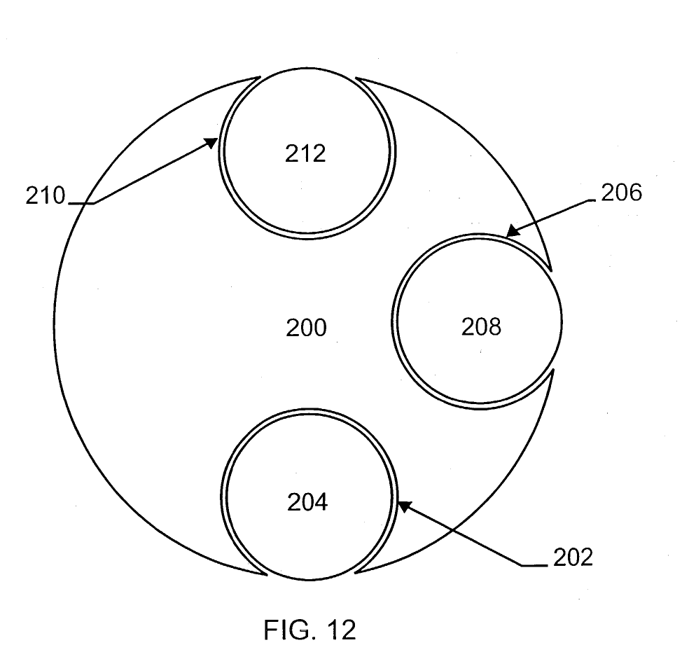

Furthermore, these color coded comp chips could be easily organized in a system or tray. One example is illustrated in FIG. 12 where comp chips, formed as annular discs, are divided by color and placed in a tray 200. A first chip slot 202 holds a first stack of comp chips 204 of the first color. A second chip slot 206 holds a second stack of comp chips 208 of the second color. A third chip slot 210 holds a third stack of chips 212 of the third color. In this way, an entity, such as a casino, is able to provide their employees with a neatly arranged apparatus and system for quickly distinguishing between the values of the different complimentary gifts indicated on the comp coupons. Even though the relative value is known, the employee of the entity still is not aware of the specific complimentary gift which is indicated on the comp coupon. Therefore, a matter of chance and luck is still present, even though the entity is aware of a particular possible range or total value of the set of chips.

Also, particular groups or series of complimentary items may be indicated with serial numbers. A portion of the serial number may be a numerical indication of a relative average value of the comp coupon on the complimentary item. Particularly, if the value of the entire series is known it may be divided by the number of complimentary items or comp coupons in that series and which results in a “factor.” The factor (without a decimal) may be indicated on the complimentary item to indicate its relative average value. Therefore, a more specific relative average value, using a numerical formula, is used to indicate the relative average value of the complimentary gift indicated on the comp coupon.

As discussed above, the value of an entire series may be any appropriate value. It may include gifts of many disparate values. For example, a series may include several large value complimentary gifts, such as large cash prizes or high value prizes, while also having several small value prizes, such as free drinks or meals. The value for the entire series is then divided by the number of complimentary items in the series creating the factor. Therefore, even though a relative average value is known for the entire series, suspense is still created as to what the specific value of a particular complimentary gift, indicated on the comp coupon which may range from a very low value to a very high value.

Using a relative average value indication, such as the factor, the entity providing the complimentary item is aware of the respective and relative average values of the complimentary gifts indicated on the comp coupon of the particular complimentary item. Therefore, the complimentary items of one particular relative average value are easily distinguishable from another set of complimentary items with a different relative average value. In addition, the entity providing the complimentary item knows the total value of a particular series of comp items even without knowing the actual complimentary gift indicated on each comp coupon. Therefore, a system of allowing a quick determination of relative average value is disclosed.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device to provide an unknown complimentary gift to a person comprising:
a member comprising a first side and a second side;
a message marked on said first side; and
a coupon extending from said second side;
wherein said coupon is selectively affixed to said second side such that the person may remove said coupon from said second side.

2. A device to provide an unknown complimentary gift to a person comprising:
a first member defining a body;
a second member selectively extending from said body;
a coupon having a revealed side and a selectively hidden side;
an identifying message marked on said revealed side; and
a complimentary gift indicated on said selectively hidden side;
wherein said coupon is selectively associated with said second member such that said complimentary gift identification is not known until said hidden side is exposed.

3. A method for providing plurality of unknown complimentary gifts to a plurality of people such that a relative or average value of the unknown complimentary gift is known, the method comprising:
providing a group of items;
providing each item with a revealable, though hidden, indication of one of the unknown complimentary gifts; and
marking each item to indicate a relative or average value of the indicated unknown complimentary gift.
